(19) United States
(12) Patent Application Publication
(10) Pub. No.: US 2004/0198266 A1
(43) Pub. Date: Oct. 7, 2004

(54) Control circuitry

(76) Inventor: Kevin Lamacraft, Twickenham (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/276,753

(22) PCT Filed: May 17, 2001
(86) PCT No.: PCT/GB01/02195

(30) Foreign Application Priority Data
May 19, 2000 (GB) 0012196.2

(51) Int. Cl. H04B 1/04

(52) U.S. Cl. 455/125; 455/91; 455/115.1

(57) ABSTRACT

Control circuitry for a transmitter comprises means for receiving a first plurality of signals at different frequencies at the same time; means for generating a second plurality of signals; means for reducing the frequency of the first plurality of signals by mixing the first plurality of signals with said second plurality of signals to provide a series of samples of said first plurality of signals, wherein each of said samples is separated in time; and means for adjusting a characteristic of signals to be transmitted dependent upon said samples.

### FIELD OF THE INVENTION

The present invention relates to control circuitry and a method of controlling characteristics of signals to be transmitted, in particular but not exclusively, for use in a wireless cellular telecommunications network.

### BACKGROUND OF THE INVENTION

A typical known wireless telecommunications cellular network will now be described with reference to FIG. 1. The area covered by the network 2 is divided into a plurality of cells 4. Each cell 4 is served by a base transceiver station 6 which is arranged to transmit signals to and receive signals from terminals located in the cell 4 associated with the respective base transceiver station 6. The terminals 8 may be mobile stations which are able to move between the cells 4. Each base transceiver station is, in the GSM standard (Global System for Mobile Communications), arranged to receive N out of M available channels C1 . . . CM as illustrated in FIG. 2. The GSM standard uses a frequency division multiple access technique. Each channel has a bandwidth of 200 KHz. Each bandwidth is divided into frames F one of which is shown in FIG. 3. Each frame is divided into eight slots T0 . . . T7. The GSM standard is also a time division multiple access (TDMA) system and accordingly different mobile stations will be allocated different time slots for a given frequency. Thus, the base transceiver station will receive signals from different mobile stations in different time slots at the same frequency.

FIG. 4 shows part of a known base transceiver station 9 which is arranged to transmit N channels at the same time. For clarity, only a part of the base transceiver station is shown. The base transceiver station 9 has an antenna 10 for transmitting signals to mobile stations 8 in the cell served by the base transceiver station 9. The base transceiver station 9 comprises N transmit branches TX₁, TX₂. . . TXₙ. The base transceiver station 9 is thus provided with one transmit branch for each channel transmitted. Each transmit branch represents a different channel and is supplied with respective I and Q modulation components initially at the base band frequency.

Referring specifically to the first transmit branch TX₁ the I and Q modulation components are initially in digital form and are converted into analogue signals by respective digital to analogue converters (DAC) 12a,12b. The output of each of the digital to analogue converters 12a,12b is connected to a respective low pass filter 14a,14b. The low pass filters 14a,14b filter out unwanted components which are introduced by the digital to analogue converters 12a,12b.

The output of each of the digital to analogue converters 12a,12b is supplied to an upconverter 16. The upconverter 16 upconverts the signal from the base band frequency to the radio frequency.

The output of the upconverter 16 is input to a high power amplifier 30 which amplifies the signal by a fixed amount. The output of the high power amplifier 30 is supplied to the antenna 10 via a duplex filter 42. A coupler 32 is provided which removes a small proportion of the signal output by the power amplifier and inputs it to the power control circuitry.

The power control circuitry 28 is used to compensate for variations caused for example by age related drift, temperature related drift or other types of drift. These types of drift can lead to errors in transmission which decrease link performance and/or lead to other undesirable effects.

One problem with known transceiver stations is that it is necessary to provide a transmit branch including a power control loop for each channel. This substantially increases the cost of the base transceiver station. Another problem with power control of the 8-phase shift keying modulation techniques used in EDGE modulated GSM, or any other non-constant envelope modulation, is how to deal with the amplitude modulation that occurs during some of the phase state transitions. This amplitude variation due to the necessary modulation is difficult to distinguish from amplitude variations caused by incorrect power level setting. Conventional techniques fail to deal adequately with this problem because of the high digital signal processing demands which would be required.

It is an aim of the embodiments of the present invention to address these problems.

### SUMMARY OF INVENTION

According to an aspect of the present invention, there is provided control circuitry for a transmitter comprising: means for receiving a first plurality of signals at different frequencies at the same time; means for generating a second plurality of signals; means for reducing the frequency of the first plurality of signals by mixing the first plurality of signals with said second plurality of signals to provide a series of samples of said first plurality of signals, wherein each of said samples is separated in time; and means for adjusting a characteristic of signals to be transmitted dependent upon said samples.

Preferably, the characteristic is adjusted in dependence upon the same characteristic of said samples. Various embodiments are possible. For example, the characteristic for adjusting can be selected from one or more of the phase, amplitude and power of a signal to be transmitted.

Preferably, said reducing means is arranged to produce a plurality of sets of samples, each set of samples comprising one sample for each of said first plurality of samples.

In preferred embodiments each of said first plurality of signals is transmitted for a predetermined transmit period and the reducing means is arranged to generate a set of samples in a period equal to or less than the transmit period.

In one envisaged embodiment the transmit period is a GSM timeslot.

Preferably, the first plurality of signals are reduced by said reducing means so that the series of samples are at the same frequency.

Preferred reducing means comprise filter means for filtering out those of the plurality of first signals which after reducing are not at said same frequency. Such reducing means comprise mixer means.

Preferred generating means comprise a direct digital synthesiser. The generating means can be arranged to generate each of said second plurality of signals in turn. Such generating means comprise means for generating a plurality of signals at an initial frequency and means to increase the frequency thereof to provide said second plurality of signals at a higher frequency.

The increase in frequency of the generated signals from the initial frequency to the higher frequency is implemented by one or more means selected, for example, from multiplier means, harmonic means and signal adding means.

In some embodiments, the circuitry comprises a memory, wherein the samples are stored in the memory and retrieved therefrom to perform signal correction at a rate slower than the sample generation rate.

Preferably, the adjusting means adjusts the power of signals to be transmitted based on a comparison of each respective sample with a reference signal.

A transmitter embodying the present invention may incorporate control circuitry as disclosed herein. For example, a base transceiver station in a wireless network can incorporate such power control circuitry.

According to another aspect of the present invention, there is provided a method of controlling a characteristic of signals to be transmitted, comprising the steps of: receiving a first plurality of signals at different Frequencies at the same time; generating a second plurality of signals; reducing the frequency of the first plurality of signals by mixing the first plurality of signals with said second plurality of signals, whereby a series of samples of said first plurality of signals are provided, each of said samples being separated in time; and controlling a characteristic of signals to be transmitted dependent upon said samples.

In methods applied to EGDE modulated GSM techniques, multiple frequencies are sampled during a midamble of the EDGE modulated GSM signal.

Thus, it may be possible to provide control circuitry and particularly power control circuitry for a transmitter which is capable of handling a number of signals at different frequencies, which may be different channels. Accordingly, the number of components which are required may be reduced as compared with known transmitters.

### BRIEF DESCRIPTION OF DRAWINGS

For a better understanding of the present invention and as to how the same may be carried into effect reference will now be made, by way of example only, to the accompanying drawings in which:

FIG. 1 shows a typical wireless cellular telecommunications network;

FIG. 2 shows channels which may be transmitted by a base transceiver station;

FIG. 3 illustrates the structure of a time frame;

FIG. 4 shows part of a typical base transceiver station;

FIG. 5 shows a power control architecture embodying the present invention;

FIG. 6A shows different carrier frequencies transmitted simultaneously;

FIG. 6B illustrates a method of sampling during a time slot;

FIG. 6C illustrates a control signal;

FIG. 6D illustrates the output of the bandpass filter of FIG. 5; and

FIG. 7 illustrates a method of sampling embodying the present invention.

### DETAILED DESCRIPTION OF EMBODIMENTS OF THE INVENTION

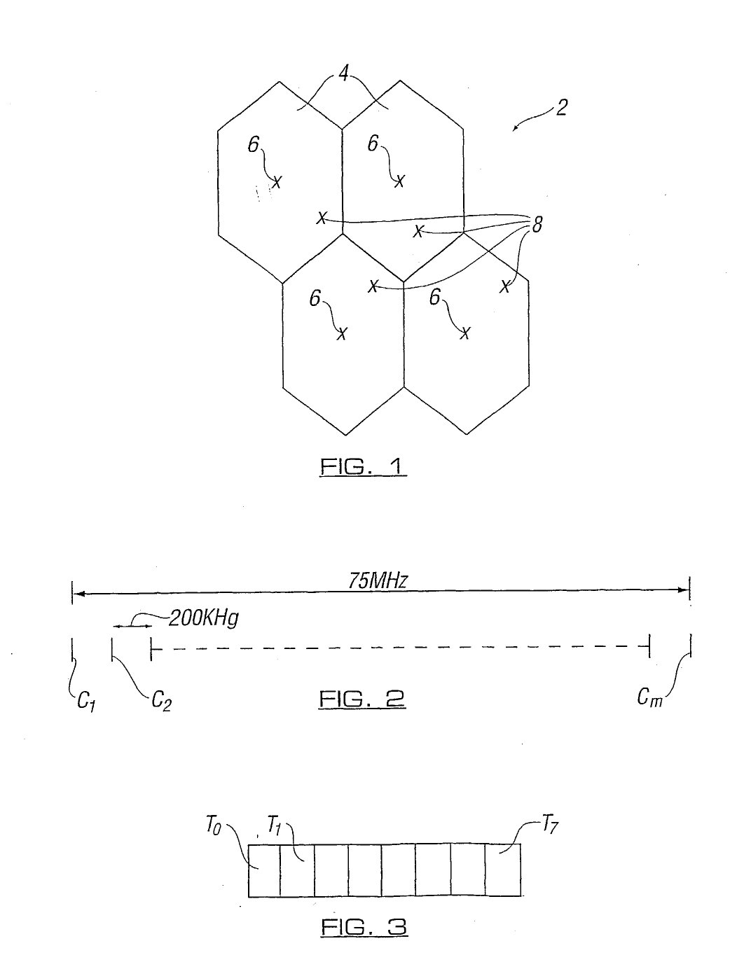

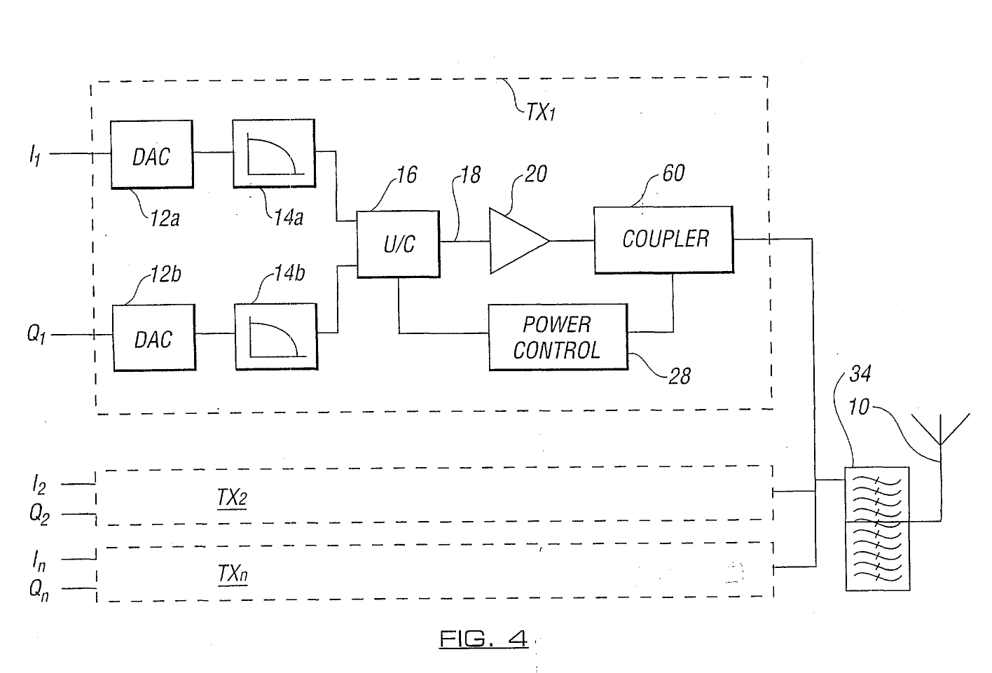

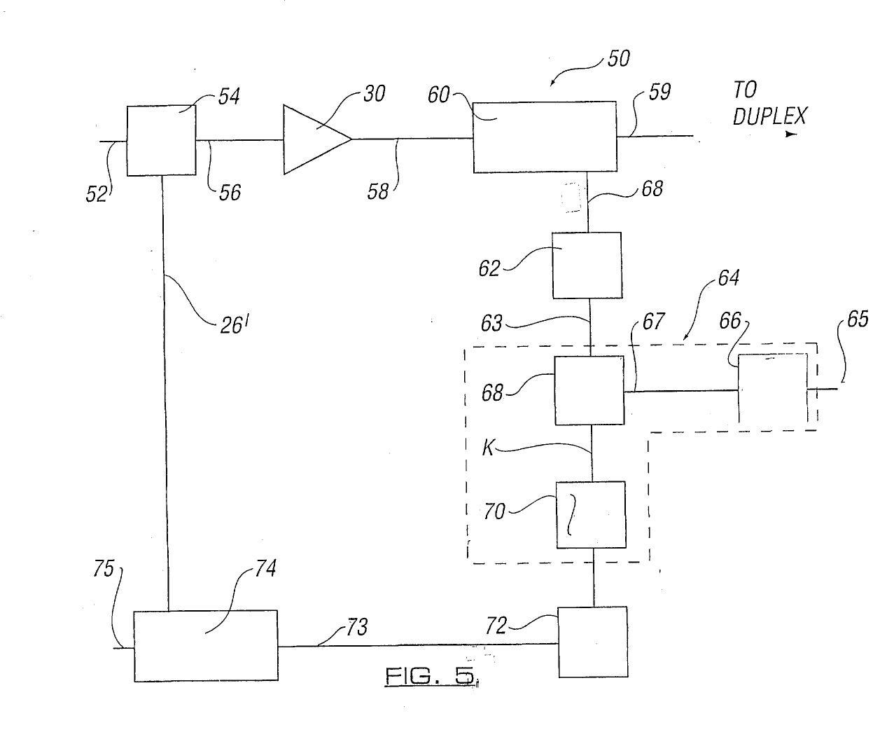

FIG. 5 shows power control circuitry 50 which in FIG. 5 is incorporated in a base transceiver station, for example used in a network such as that illustrated in FIG. 1. The power control circuitry of FIG. 5 incorporates multicarrier capabilities and thus replaces all of the prior art transmit branches illustrated in FIG. 4. The power control circuitry will be described in the context of a GSM transmitter system.

However, it should be appreciated that embodiments of the present invention can be used with any other suitable telecommunications standard.

The power control circuitry 50 comprises a multicarrier generation block 54, a power amplifier 30′ and a coupler 60. The power control circuitry 50 also includes a single feed back loop comprising an isolator 62, a multicarrier radio frequency sampler 64, a power detection block 72 and a corrective signal generation block 74.

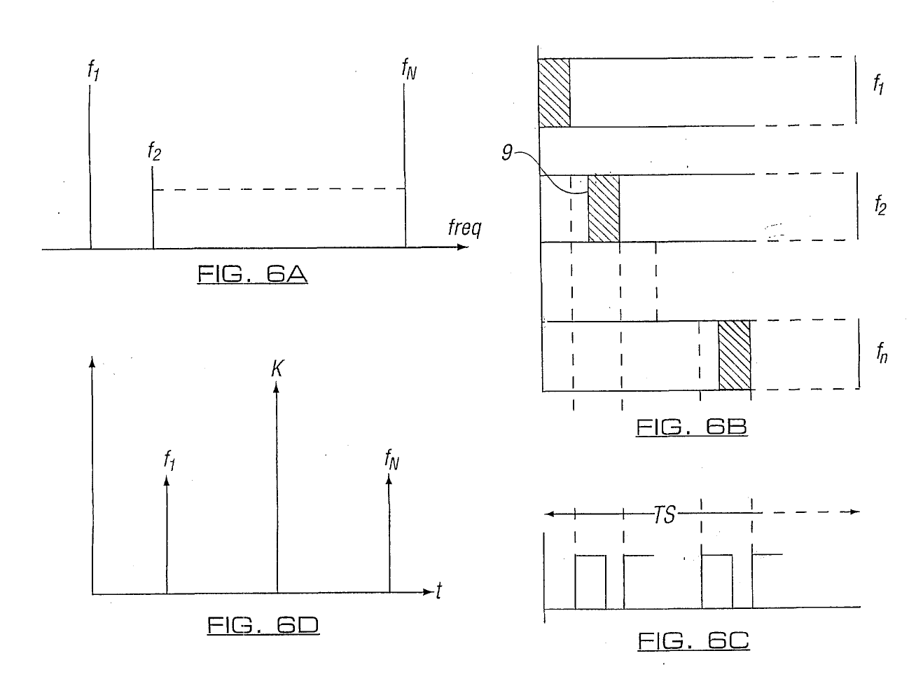

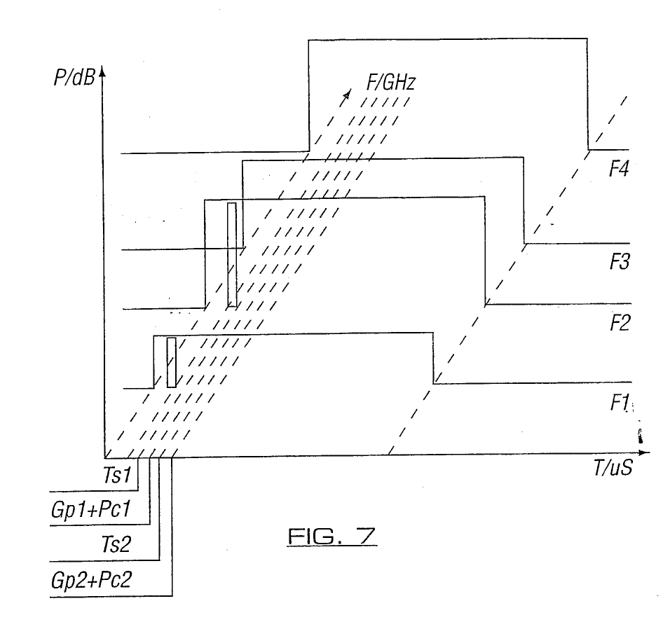

The multicarrier generation block 54 has a first input 52 for receiving data. The date received at input 52 comprises data for all of the N transmission channels. The block 54 comprises an upconverter which receives the data for the N channels and outputs modulated radio frequency carriers corresponding to each of the channels on line 56. The output 56 of the multicarrier generation block 54 comprises a plurality of radio frequency carriers, each being modulated to carry the data of a different channel. The output 56 of the multicarrier generation block 54 is supplied to a power amplifier 30′ for amplifying the input signal by a fixed amount. The output of the power amplifier 30′ as it would appear on signal line 58 is illustrated in FIG. 6A.

FIG. 6A shows the multicarrier environment in the frequency domain. There are N different carrier frequencies present at the same time, for example F₁, F₂ . . . F_{N}, each of which is at a radio frequency corresponding to a channel C₁, C₂ . . . C_{N}. Each carrier frequency F₁, F₂. . . F_{N} has a bandwidth of 200 KH_{z} as in the current GSM standard. Adjacent frequencies F₁, F₂. . . F_{M} are spaced apart by at least 600 KH_{z}. However, the frequencies F₁, F₂ . . . F_{N} used at any time are not necessarily adjacent frequencies.

Referring back to FIG. 5, the N different carriers and the signals carried thereby are supplied to a coupler 60. The coupler 60 splits the signal such that a first representative signal is supplied on line 59 to the antenna 10 via the duplex filter (not shown) and a second representative signal is supplied to the feed back loop via line 61. The signal on line 61 is input to the isolator 62 which prevents stray signal components, for example reflected from line 59. The output 63 of the isolator 62 is supplied to the multicarrier frequency sampler 64. The multicarrier frequency sampler 64 comprises a direct digital synthesiser 66, a mixer 68 and a bandpass filter 70.

The mixer 68 receives the frequency domain signal illustrated in FIG. 6A on a first input (line 63) and an output of the direct digital synthesiser 66 on a second input (line 67). The direct digital synthesiser 66 is arranged to frequency hop and provides signals at lower frequencies F₁′, F₂′ . . . F_{N}′ in sequence. The mixing of the radio frequency signals on line 63 with the lower frequency signals generated by the direct digital synthesiser down converts the signal as will be explained below. The frequencies F₁′, F₂′ . . . F_{N}′ provided by the direct digital synthesiser 66 generally satisfy the criteria:

F₁−F₁′=F₂−F₂′=F_{N}−F_{N}′=K,

where K is a constant intermediate frequency.

The frequency hopping of the direct digital synthesiser 66 is controlled by a controller which provides a control signal 65. Each time the control signal 65 changes, for example from a low level to a high level, the frequency which the direct digital synthesiser 66 produces is changed. The control frequency selected is sufficiently high that the generated frequencies F₁′, F₂′ . . . F_{N}′ are cycled through many times in a time equal to a transmit burst period (timeslot) Each of the N different frequencies F₁, F₂ . . . F_{N} are down converted by the mixer and pass through the bandpass filter 70 many times in the period.

FIGS. 6B and 6C illustrate the sampling process of the multicarrier environment in the time domain. One timeslot period is shown for each of the N carriers. The illustration of FIG. 6B assumes almost perfect synchronicity, namely that the beginning and end of the time slot for each carrier occurs at substantially the same time. This assumption is valid for GSM based transceiver stations, where carriers are time constrained to be within ¼ of a bit period. The control frequency selected is sufficiently high that the generated frequencies F₁′, F₂′ . . . F_{N}′ are cycled through many times in a time equal to a transmit burst period (timeslot). The sampling sequence is cyclic so that all of the carriers are oversampled with respect to the bit period. This oversampling increases the accuracy of the technique. The number of cycles employed depends on the accuracy required for generating the correction signal. It will also depend on the modulation technique used. Generally, the more complex the modulation technique, the higher will be the number of cycles to achieve a satisfactory result. Each of the N different frequencies F₁, F₂ . . . F_{N} are down converted by the mixer and pass through the bandpass filter 70 many times in the period.

FIG. 6C shows this control signal frequency. The signal on line 63 initially at frequency F₁ is sampled at the beginning of a burst period, the synthesiser being tuned to the frequency F₁′. When the sampling of the first signal initially at F₁ is completed, the direct digital synthesiser 66 is tuned to provide the second frequency F₂′. As can be seen from FIG. 6B, it takes the direct digital synthesiser 66 a small amount of time to change from providing the frequency F₁′ to providing the frequency F₂′. During this guard period, marked by reference g, no sampling will take place. When the direct digital synthesiser 116 provides the second synthesiser frequency F₂′, the signal initially at the second carrier F₂ will be sampled. This is carried out for each of the N carrier frequencies F₁, F₂ . . . F_{N}.

The output of the mixer which thus corresponds to K is input to the bandpass filter 70. The bandpass filter 70 is tuned to the frequency K. Therefore, any signals which are not at frequency K are filtered out by the bandpass filter 70.

When the direct digital synthesiser 66 provides a signal at frequency F₁′, the signals at frequency F₁ are reduced to K, as explained above. However the signals at frequencies F₂′ . . . F_{N}′ are reduced to respective different frequencies which are different to frequency K. Accordingly, when the output of the mixer 68 is input to the bandpass filter 70 only the signal at frequency K derived from the frequency F₁ is output by the filter 70, the other signals being reduced or removed by the filter 70. This process is repeated each time the frequency provided by the synthesiser 66 changes. The output of the bandpass filter 70 with respect of time is shown in FIG. 6D. In such a case the bandpass filter 70 would be tuned to the intermediate frequency K and only that frequency would be allowed to pass to the output of the bandpass filter 70.

In the current GSM standard, the bit period is 3.69μ seconds. In one embodiment of the present invention, the number of channels and hence different carrier frequencies which will be sampled at the same time within the base transceiver station will be four. If it is assumed that the guard period and the sampling period are the same, then the direct digital synthesiser 66 will need to hop between the four frequencies required to down convert a respective one of the received channels at a rate of 461 ns. In other words, the time between the ending of one sampling period and the beginning of the next sampling period will be 461 ns and the length of each sampling period will be 461 ns. However, it should be appreciated that it is not essential that the sample and guard times be equal.

The sampling technique described in relation to FIGS. 6A to 6D is illustrated in FIG. 7 for the case of 4 carriers at frequencies F₁ to F₄. The first frequency F₁ is sampled for a time period Tp₁. The correction signal P_{c1} is then applied to carrier at F₁ at an optimum time within the guard period Gp₁. The sample period employed will depend on the modulation and on the amount of processing required to generate the correction signal. The optimum time for correction depends on the required functionality of the power control as will be apparent to a skilled person. The next event is then the sampling of carrier at F₂ over the time period Tp₂. The correction signal P_{c2} for the carrier at F₂ is then applied at an optimum time within the time period Gp₂.

Thus, each of the N carriers F₁ to F_{N} is sampled by the frequency hopping direct digital synthesiser, which is applied to the local oscillator port of the down-conversion stage for a period T_{S} with a guard period Gp, to allow for frequency hopping and settling. This additional time division multiplexing means that each of the N carriers is sequentially down-converted to K in real time. However, with respect to the timeslot period, all N carriers are down-converted many times such that a corrective power control signal P_{c} can be generated and applied to each of the N carriers many times in one timeslot. The down-conversion to a constant intermediate frequency, K permits analogue filtering to be applied to each of the N carriers in turn hence minimising the potential correction signal errors due to the other carriers within the transmitted burst.

The above-described rapid sampling technique allows the power of each carrier to be detected successively and many times within a transmit burst period, as will be explained below.

The output of the bandpass filter 70 is input to the power detection block 72. The power detection block 72 detects the power of the down-converted frequency carrier K output from the bandpass filter 70 of the multicarrier frequency sampler 64. The result 73 of the power detection by block 72 is supplied to the corrective signal generation block 74 which also receives a reference signal 75 at a second input. The reference signal is a voltage v(t), that is derived from a deterministic knowledge of the applied modulation. The corrective signal generation block 74 implements an algorithm which compares the power P₁, P₂ . . . P_{N} of the respectively sampled carriers C₁, C₂ . . . C_{N} with the reference signal. The algorithm mathematically compares the measured signal with the reference signal to generate a difference signal and then outputs a correction value in order to minimise the difference signal. The corrective signal generation block 74 produces a control signal 26′ based on the correction value which is input to the multicarrier block 54 to apply appropriate power control to the signal to be transmitted. A skilled person will be aware of many ways in which the control signal 26 can be used by the multicarrier generation block 54 to apply the power control. In this embodiment, the control signal 26 is digitally summed within the modulator that generates the multicarrier signal.

It will be apparent that the power control circuitry of FIG. 5 provides a way of achieving simultaneous detection with respect to the transmit burst period of one or a plurality of carriers. This is achieved using only one power control loop, permitting a corrective power control signal to be applied to each of a plurality of carriers within a multicarrier environment many times within each transmit burst period. In the exemplary embodiments, four GSM modulated radio frequency carriers can be detected and corrected in a single timeslot.

The maximum switching speed of currently available direct digital synthesisers 66 is equal to 2/F_{c} where F_{c} is the clock frequency. On commercially available direct digital synthesiser has a clock speed of 300 MHz. This would mean that the maximum switching speed would be 7 ns so the target within 461 ns outlined hereinbefore is clearly possible.

With the current commercially available direct digital synthesisers, the maximum frequency which can be generated is around 40% of the clock frequency. Thus, with a clock speed of 300 MHz, the maximum output frequency would be around 120 MHz. The maximum frequency which will be required will depend on the standard with which the receiver is designed to operate. For example, for one GSM standard, the frequencies required from the synthesizer are around 700 MHz whilst for other standards, higher frequencies of around 1600 MHz would be required.

There are several ways in which this increase in the frequency output of the synthesiser can be achieved. The first method is to simply use a multiplier to increase the frequency output by the direct digital synthesiser. The same multiplier can be used to provide the different frequencies. The base frequency output by the synthesiser would then be altered as required. The multiplier would be located between the output of the synthesiser and the input to the mixer. Frequency multipliers are well known and typically comprise a non linear circuit which is used to generate a signal at a multiple of the input signal frequency. Whilst multipliers can be used in certain embodiments of the present invention, the signal output by the multiplier includes unwanted noise. In an alternative, the base frequency of the synthesiser remains the same and the factor by which the output of the synthesiser is multiplied by the multiplier is altered in order to obtain the required output frequency for the mixer.

A second method is to make use of the fact that the direct digital synthesiser will produce harmonics of the main frequency. In normal use, these harmonics may be removed by filtering. For example, if the main frequency output by the direct digital synthesiser is f then harmonics will be output at 2f, 3f . . . nf where n is an integer. For example, if the main frequency output by a direct digital synthesiser is 120 MHz then harmonics will be output at 240 MHz, 360 MHz etc. If for example a frequency around 1500 MHz is required, then the harmonic at, for example, 1440 MHz could be used. As the harmonics will have a smaller amplitude than the main frequency, an amplifier is required. Additionally, a filter will be required to filter out the unwanted frequencies including the main frequency and the unused harmonics. In order to modify the embodiment shown in FIG. 5 to use this method of increasing the sampling frequency, an amplifier and filter simply need to be placed between the direct digital synthesiser 66 and the mixer 68. The base frequency from which the harmonics are obtained is altered in accordance with the frequency which is required to be input to the mixer.

In a third method of increasing the sampling frequency, a conventional technique is used. Thus, the embodiment shown in FIG. 5 could be modified to include one or more mixers between the direct digital synthesiser 66 and the mixer 68. The additional mixer would include one input from the direct digital synthesiser and one input from a fixed frequency synthesiser. The fixed frequency synthesiser would only provide a single frequency and the output of the direct digital synthesiser would be altered to ensure that the correct frequency is output to the mixer. The additional mixer would be arranged to effectively add the two frequencies together to give a higher frequency.

The length of the sampling period can be adjusted, but is limited by the variations in the signal envelope and the bandwidth of the analogue parts. Power correction can occur quickly (for example once every 2 or 3 samples) or more slowly. Accordingly, in other embodiments, the power detection block 72 has access to a memory in which the sampled powers of the responsive carriers C₁ to C_{N} are stored. The stored samples can then be read from the memory and used as required in order to apply power correction over the desired timescale. This type of slow correction may be applied for example in EDGE modulated GSM systems at a rate considerably slower than the sampling rate and/or in a time averaged manner.

EDGE modulated GSM systems use a 26 symbol long GMSK-like midamble which functions as a training sequence and so the above technique can be applied to provide power control in these systems. The multiple frequencies can be sampled during the midamble part of the burst. For example, with 4 carriers, a sample period 6 symbols long is ample to generate a power level measurement. The sampling technique described in this document can thus also be used to apply power control for either a single or multicarrier transmission environment with the proposed GSM EDGE modulation scheme.

The invention should not be limited to the configurations of the described embodiment. Specifically, the described embodiment shows an example of a configuration which may be used to implement the invention and is not intended to define the only type, configuration or interconnection of the elements which should be used.

It is not necessary to increase the frequency of the direct digital synthesiser where the sampling rate does not require it. It is also envisaged that developments will occur which will permit direct digital synthesisers to provide higher frequencies.

In the described embodiments, a single transmitter which is able to deal with all the channels is described. However, in one modification, a plurality of transmitters is provided and each transmitter is arranged to deal with a plurality of channels.

In the embodiment described hereinbefore, it is assumed that the signals which are transmitted by the base station have synchronised timing so that the bit periods in each channel are synchronised. However, in other embodiments of the invention, the channels need not be synchronised.

Whilst embodiments of the present invention have been described in relation to a GSM system, embodiments of the present invention can be used with any other suitable standard including analogue standards, other standards using time division multiple access (TDMA), spread spectrum systems such as code division multiple access (CODMA), frequency division multiple access (FDMA), space division multiple access (SDMA) and hybrids of any of these systems.

Embodiments of the present invention have been described in the context of a transmitter for a base transceiver station. However, embodiments of the present invention can be used in any other suitable transmitters such as in a mobile station as well as in other types of transmitter which are not used in cellular networks but which are arranged to transmit a number of signals, at different frequencies, at the same time. Other applications include multicarrier power control for transmitters without any receiving capability.

Other embodiments of the invention can be used similarly to apply corrections to, for example, the amplitude and/or phase of signals to be transmitted.

1. Control circuitry for a transmitter comprising:
means for receiving a first plurality of signals at different frequencies at the same time;
means for generating a second plurality of signals;
means for reducing the frequency of the first plurality of signals by mixing the first plurality of signals with said second plurality of signals to provide a series of samples of said first plurality of signals, wherein each of said samples is separated in time; and
means for adjusting a characteristic of signals to be transmitted dependent upon said samples.

2. Circuitry as claimed in claim 1, where the characteristic is adjusted in dependence upon the same characteristic of said samples.

3. Circuitry as claimed in claim 1 or 2, wherein the characteristic for adjusting is selected from one or more of the phase, amplitude and power of a signal to be transmitted.

4. Circuitry as claimed in claims 1, 2 or 3, wherein said reducing means is arranged to produce a plurality of sets of samples, each set of samples comprising one sample for each of said first plurality of samples.

5. Circuitry as claimed in any of claims 1-4, wherein each of said first plurality of signals is transmitted for a predetermined transmit period and the reducing means is arranged to generate a set of samples in a period equal to or less than the transmit period.

6. Circuitry as claimed in claim 5, wherein the transmit period is a GSM timeslot.

7. Circuitry as claimed in any preceding claim, wherein the first plurality of signals are reduced by said reducing means so that the series of samples are at the same frequency.

8. Circuitry as claimed in claim 7, wherein the reducing means comprises filter means for filtering out those of the plurality of first signals which after reducing are not at said same frequency.

9. Circuitry as claimed in any preceding claim, wherein the reducing means comprises mixer means.

10. Circuitry as claimed in any preceding claim, wherein the generating means comprises a direct digital synthesiser.

11. Circuitry as claimed in any preceding claim, wherein the generating means is arranged to generate each of said second plurality of signals in turn.

12. Circuitry as claimed in any preceding claim, wherein the generating means comprises means for generating a plurality of signals at an initial frequency and means to increase the frequency thereof to provide said second plurality of signals at a higher frequency.

13. Circuitry as claimed in claim 12, wherein the increase in frequency of the generated signals from the initial frequency to the higher frequency is implemented by one or more means selected from multiplier means, harmonic means and signal adding means.

14. Circuitry as claimed in any preceding claim comprising a memory, wherein the samples are stored in the memory and retrieved therefrom to perform signal correction at a rate slower than the sample generation rate.

15. A method as in any of claims 1-14, wherein the characteristic adjusting means adjusts the power of signals to be transmitted based on a comparison of each respective sample with a reference signal.

16. A transmitter incorporating control circuitry as claimed in any preceding claim.

17. A base transceiver station incorporating control circuitry as claimed in any of claims 1-15.

18. A method of controlling a characteristic of signals to be transmitted, comprising the steps of:
receiving a first plurality of signals at different frequencies at the same time;
generating a second plurality of signals;
reducing the frequency of the first plurality of signals by mixing the first plurality of signals with said second plurality of signals, whereby a series of samples of said first plurality of signals are provided, each of said samples being separated in time; and
controlling a characteristic of signals to be transmitted dependent upon said samples.

19. A method as claimed in claim 18, wherein multiple frequencies are sampled during a midamble of an EDGE modulated GSM signal.
